(19) United States
(12) Patent Application Publication
(10) Pub. No.: US 2015/0285252 A1
(43) Pub. Date: Oct. 8, 2015

(54) GRINDER PUMP WITH REGENERATIVE IMPELLER

(71) Applicant: CRANE PUMPS & SYSTEMS, INC., Piqua, OH (US)

(72) Inventors: Mark Kowalak, Troy, OH (US); Brandon Cross, Troy, OH (US); Kirk Neer, St. Paris, OH (US)

(21) Appl. No.: 14/439,383

(22) PCT Filed: Nov. 1, 2013
(86) PCT No.: PCT/US13/67927

§ 371 Date: Apr. 29, 2015

Related U.S. Application Data
(60) Provisional application No. 61/721,835, filed on Nov. 2, 2012.

(51) Int. Cl. F04D 7/04; B02C 18/00

(52) U.S. Cl. CPC F04D 7/045; B02C 18/0092

(57) ABSTRACT

A pump is provided to convey solids-containing wastewater from a basin, such as a sewage basin. The pump has a pump housing that is adapted to be arranged in the basin with an inlet thereof positioned to receive the solids-containing wastewater. An outlet of the pump housing is arranged to eject pressurized wastewater through an outlet of the basin. A pump chamber is arranged in a flow conduit formed in the pump housing between the inlet and the outlet. A regenerative turbine impeller is arranged for rotation in the pump chamber. A grinder is also arranged for rotation in the pump housing between the inlet and the outlet, especially between the inlet and the pump chamber.

### TECHNICAL FIELD

The disclosed embodiments of the present invention relate to improvements in a grinder pump, particularly a pump intended for use in a pressurized sewage application. One difference from the known grinder pumps is the use of a regenerative turbine hydraulic instead of a centrifugal or progressing cavity hydraulic.

### BACKGROUND

A patent owned by the applicant, U.S. Pat. No. 7,357,341, describes the application of grinder pumps in pressurized wastewater applications. In that patent, a two-stage vortex centrifugal pump is used to increase the output head achieved, compared to a single-stage centrifugal. Progressing cavity pumps have poor reliability in abrasive waste water application. Due to the unpleasant nature of maintaining a submersible pump in a sewage basin setting, this poor reliability makes progressing cavity pumps undesirable, even with their ability to provide relatively high head at low flow rates.

Another patent owned by the applicant, U.S. Pat. No. 8,128,360, describes a vortex pump impeller that provides improved head by the incorporation of splitter blades onto the impeller face. From that patent, and other patents cited in its prosecution, it is known to use vortex pumps for liquids that contain a substantial amount of foreign matter such as solids and/or fibriform matter. The vortex chamber allows foreign matter to pass without clogging the impeller, which is rotationally mounted in an adjoining recessed chamber. A known trade-off from avoiding contact of foreign matter with the impeller is a loss of efficiency and head when compared to a more conventional centrifugal pump.

A regenerative pump generally differs from a centrifugal pump in the flow of the fluid on the impeller. When a fluid encounters an impeller of a centrifugal pump, the fluid predominantly passes through the impeller only once, the encounter resulting in the fluid being centrifugally propelled into a volute that is radially beyond the impeller. The regenerative nature of the regenerative turbine lies in the many encounters with the impeller made by the fluid. Vanes of the regenerative turbine interact with very tight internal clearances to impose a circulatory pattern onto the fluid, so the fluid enters and exits the impeller vane multiple times before exiting the pump, with each encounter building up the pressure, so long as the clearances are tight enough to prevent pressure loss.

The need for these tight internal clearances has heretofore limited the use of regenerative turbines to so-called “clean liquids.” The Hydraulic Institute Standard 1.3 concerning regenerative turbine pumps says: “Due to the close clearances of the dam and side walls, it is necessary to have clean liquid. The particle size should be no greater than 0.025 mm (0.001 inches). Particles exceeding this parameter will result in reduced performance and the subsequent need to replace the close-fitting casing and impeller” (Section B1.3.1.5.1 “Clean Liquids).

This need for clean fluids leads some manufacturers of regenerative turbine pumps to use a strainer at the suction of the pump, to prevent solids from entering the turbine.

With this in mind, it is not surprising that U.S. Pat. No. 5,507,617 teaches regenerative turbine pumps as being appropriately used in boiler feed water systems, rocket booster systems, car wash applications, chemical feed systems, chlorine injection systems, condensate return systems, dry cleaning systems, electronic cooling systems, high pressure sprays, petroleum refining processes, air conditioning, refrigeration and heating applications.

Another known application of regenerative turbine pumps is in automobiles, where the combination of high head at low flow and low power consumption make them ideal as fuel pumps.

It is therefore an unmet advantage of the prior art to provide unexpectedly improved efficiency, high head, and abrasion resistance from that of a vortex pump impeller and regenerative pumps as previously known.

### SUMMARY

This and other unmet advantages are provided by a pump for conveying solids-containing wastewater from a basin. Such a pump has a pump housing that is adapted to be arranged in the basin, so that an inlet thereof is positioned to receive the solids-containing wastewater. The pump housing has an outlet to eject wastewater containing comminuted solids that has been pressurized through an outlet of the basin. A pump chamber is a part of a flow conduit that is positioned in the pump housing between the inlet and the outlet.

A regenerative turbine impeller is arranged for rotation in the pump chamber, and a grinder is arranged for rotation in the pump housing between the inlet and the outlet.

In many of the embodiments, the grinder is arranged in the pump housing between the inlet and the pump chamber.

In the preferred embodiments, the pump further comprises a drive shaft with both the regenerative turbine impeller and a cutter of the grinder mounted thereupon.

### BRIEF DESCRIPTION OF THE DRAWINGS

A better understanding of the disclosed embodiments will be obtained from a reading of the following detailed description and the accompanying drawings wherein identical reference characters refer to identical parts and in which:

FIG. 1 is a pressure (and efficiency) versus capacity chart for various types of pumps; and

FIG. 2 is a side section elevation view of an embodiment of grinder pump having a regenerative turbine hydraulic.

### DETAILED DESCRIPTION

The ongoing desire for energy efficiency in residential sewage pump applications presents a need to replace centrifugal pump technology with a more effective technology. As will be shown, centrifugal pumps can provide a flow rate that easily meets or exceeds the requirements for residential sewage applications. This is particularly the case when a centrifugal pump is operated at a high pressure head, as the pump is likely operating at a flow rate well below the best efficiency point (BEP) of the pump. This results in higher power draw and motor amperage.

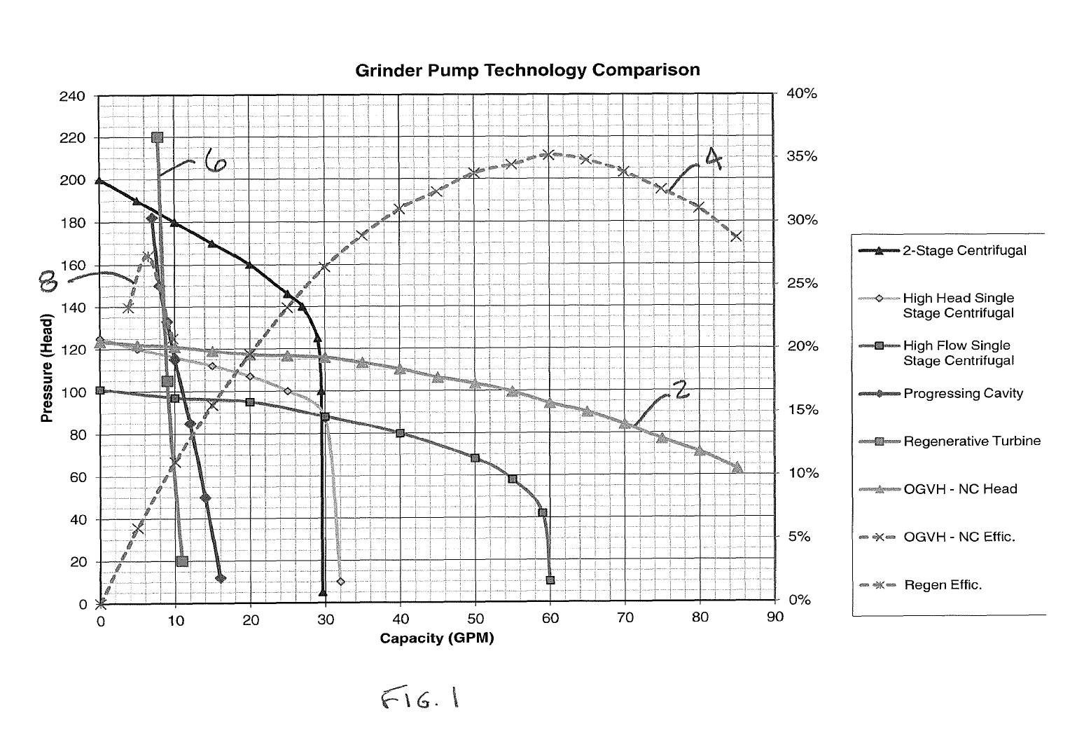

As a category, regenerative turbines can meet the flow rate needed at an equivalent or better pressure head and a lower power draw. Of these variables, pressure head is the most important and a pressure of 200 ft Total Dynamic Head (“TDH”) is highly desirable. FIG. 1 shows performance data for several different types of pumps, including some efficiency data. In this chart, the pressure head developed by a pump is read on the left side of the chart. For the efficiency curves, which are shown in dashed lines, the efficiencies are read on the right side of the chart. The maximum of the efficiency curve represents the BEP for the configuration. Of particular interest are the head and efficiency curves 2, 4 for a typical single stage centrifugal grinder pump (without the cutter feature) that is available from Crane Pumps and Systems and the head and efficiency curves 6, 8 for regenerative turbine pump as described herein.

Using known methods for sizing a centrifugal pump to have a BEP at 15 gpm, it can be determined that the ideal minimum size of the internal passageway (the “cutwater”) is slightly less than 0.375 inch diameter. Experimental testing by the applicants shows that a cutwater of less than about 0.625 inches will tend to clog with solids. Using this larger cutwater to design the pump will increase the BEP to approximately 45 gpm. Since the BEP flow rate is never met, a pump that runs out to 30 gpm will be operating at a lower efficiency and require more horsepower, or, expressed in another manner, more amperage.

In testing conducted to date, using sand and pre-ground media as the solids, a regenerative turbine impeller has operated in a pump as described below without clogging, using a 0.625 inch passageway. It appears that the solids are stirred by the swirling induced by the impeller. It also appears to be possible that the turbine blades result in additional cutting, which may be even more accentuated when the solids are of a more fibrinoid nature. In the testing to date, the hydraulic end is capable of discharge pressures as high as 350 ft TDH, but is being operated at only about 200 ft TDH.

These test results are very unexpected when the normal standards for tolerating solids in a regenerative turbine are considered.

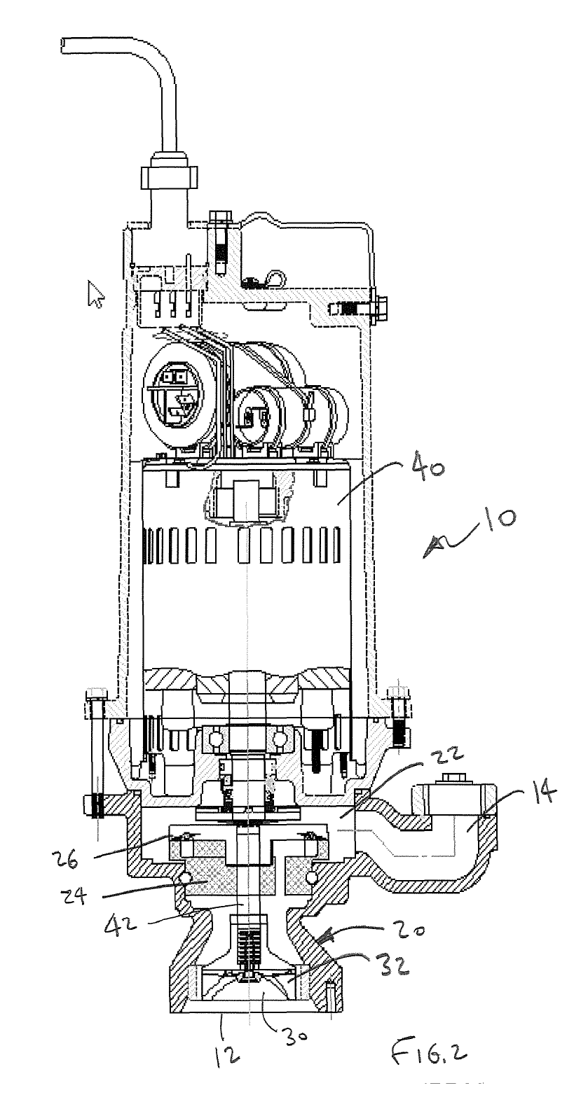

FIG. 2 shows an embodiment of a single stage grinder pump 10 containing a pump housing 20 with a pump chamber 22 and a grinder 30. Liquid, typically containing foreign matter, enters the pump 10 through inlet 12, depicted in this embodiment as being on a lower surface of the pump. Since the pump 10 will typically be installed in a sump basin (not shown) that receives the liquid, the lower surface opening 12 is particularly useful for drawing down the level in the basin. The motor 40 that provides rotational torque to the impellers in the pump 10 is actuated by a level sensing device (not shown) positioned in the basin, once a threshold level of liquid has accumulated. As the liquid and any entrained solids enter the inlet 12, the solids are comminuted in the grinder 30, where a rotating cutter 32 is mounted near or at the end of a drive shaft 42 driven by the motor 40. Since the structures of the grinder 30 will tend to throttle the flow rate to the pump chamber 22, it may be necessary in some situations to adjust the spacing of cutting elements (not shown) to optimize flow. Overall, the operation of a grinder 30 such as this is well-known in the art and the adjustments are within the capabilities of one of skill in this art.

In the depicted embodiment, the material, both liquid and entrained solids, that passes through the grinder 30 flows axially upward into the pump chamber 22. At that point the material flow past a raceway 24 and the liquid and entrained materials are subjected to the interaction of the rotationally stationary raceway and the regenerative turbine impeller 26, which is provided with vanes (not shown in FIG. 2) and driven by the same drive shaft 42 that drives the cutter 32. The regenerative turbine impeller 26 operates according to known principles and the liquid and entrained materials end up, after passing through the impeller vanes several times, in the outlet 14, from which it is piped to an elevated discharge point in the sewage basin. At this point, the liquid has been pressurized to the range of about 200 ft TDH and some significant comminution has occurred, so that it flows freely.

Having shown and described a preferred embodiment of the invention, those skilled in the art will realize that many variations and modifications may be made to affect the described invention and still be within the scope of the claimed invention. Thus, many of the elements indicated above may be altered or replaced by different elements which will provide the same result and fall within the spirit of the claimed invention. It is the intention, therefore, to limit the invention only as indicated by the scope of the claims.

What is claimed is:

1. A pump for conveying solids-containing wastewater from a basin, comprising:
a pump housing, adapted to be arranged in the basin, having an inlet to receive the solids-containing wastewater and an outlet to eject pressurized wastewater through an outlet of the basin, with a pump chamber arranged therebetween;
a regenerative turbine impeller arranged for rotation in the pump chamber; and
a grinder, arranged for rotation in the pump housing between the inlet and the outlet.

2. The system of claim 1, wherein:
the grinder is arranged in the pump housing between the inlet and the pump chamber.

3. The system of claim 1 or 2, further comprising:
a drive shaft, on which are mounted each of: the regenerative turbine impeller and a cutter of the grinder.
